(19) United States
(12) Patent Application Publication
(10) Pub. No.: US 2026/0329712 A1
(43) Pub. Date: Oct. 22, 2026

(54) AUTOMATED COMPUTER JOURNEY DETECTION

(71) Applicant: Performance Horizon Group Ltd. t/a Partnerize, Newcastle upon Tyne (GB)

(72) Inventors: Erez Nahom, Ramat Gan (IL); Yury Gubman, Jerusalem (IL); Tom Shor, Tel Aviv-Yafo (IL)

(21) Appl. No.: 19/633,029

(22) Filed: Mar. 30, 2026

Related U.S. Application Data
(60) Provisional application No. 63/781,996, filed on Apr. 2, 2025.

(51) Int. Cl. G06F 11/32; G06F 11/30; G06F 40/40

(52) U.S. Cl. CPC G06F 11/323; G06F 11/3041; G06F 40/40

(57) ABSTRACT

The presently disclosed subject matter includes a computerized method and system dedicated for automatically identifying use-case related interactions and corresponding use-case related journeys. According to the disclosed technique journeys related to a specific use-case of interest are identified by applying predictors on a database on interactions. The predictors accurately define the use-case and are generated by a specially designed learning process, which does involve learning applied on the journeys themselves (targets).

### CROSS-REFERENCE TO RELATED APPLICATION

This present application claims priority to U.S. Provisional Patent Application 63/781,996, filed on Apr. 2, 2025, the entire contents of which are incorporated herein by reference.

### FIELD OF THE PRESENTLY DISCLOSED SUBJECT MATTER

The presently disclosed subject matter relates to computerized systems and methods of tracking users' activity on the internet.

### BACKGROUND

User's interactions include events recorded in browsing history of the user while interacting with any type of computer device (e.g., desktop computer, laptop computer, smartphone, or any other web-connected device). Such events include for example: page views, mouse clicks, mouse movements, scroll depth, navigation patterns, session recording, site speed, etc. Tracking user activity on the internet includes the monitoring of users' interactions on various websites and using this information for obtaining various benefits.

Recorded user's interactions can be used for determining various metrics concerning the users including for example, demographic of users, their likes and dislikes (e.g., favored products—based on number of page views and page bounces), and online behavior (e.g., areas of interest, browsing habits, conversion rates, etc.). The recorded information can be further analyzed and used for deducing various insights. For example, recorded user's interactions can be used for fraud detection in various fields (e.g., intelligence, security, and elections fraud) based on the identification of user's behavioral patterns which are indicative of fraudulent intent and actions. Recorded users' interactions can also be used for identifying user interface design flaws, which influence conversion rates, and help to correct such flaws and improve user experience, and benefit from higher customer lifetime and higher conversion rates.

### GENERAL DESCRIPTION

To obtain valuable information regarding a specific use-case by the analysis of recorded user's activity it is first required to identify in the recorded data, users'-journeys which are related to the use-case. The term “user-journey” (or “user-interaction journey” or simply “journey”) refers to a sequence of user interactions which are all related to a specific use-case and performed by the same user. The term “use-case” refers to a certain topic or area of interest. For example, a use-case can be any one of: purchase of health insurance (e.g., of a certain insurance company), purchase of a car (e.g., of a certain type of car), online gambling (e.g., of a certain company), online health-care services (e.g., of a certain heath-care provider), online elections (e.g., of a certain campaign), online banking (e.g., of a certain bank), etc.

FIG. 1 schematically illustrates an example of a user-journey related to a use-case of luxury cars purchase. Per the illustrated example, a sequence of recorded interactions performed by a single user are identified revealing a user's journey. A first interaction (e.g., mouse click) recorded in a google search page, where a search for luxury cars is conducted, by the user. A second interaction (e.g., mouse click), recorded on Mercedes webpage. A third interaction (e.g., mouse click) recorded in a luxury car related blog, which is followed by a fourth interaction (e.g., mouse click) recorded on Porsche website and a fifth interaction recorded on Porsche's website signup page (e.g., mouse hover). A final interaction (e.g., page scroll) is recorded on the car-care page on Amazon website. The interactions are distributed over a timeline according to their time of occurrence.

As mentioned above, by analyzing journeys (e.g., by applying appropriate computer implemented logic) various value points, including observations and recommendations, can be deduced from the user behavior exhibited in the journey.

For example:
An observation that the user has dropped out after visiting Mercedes website and did not precede to a purchase a Mercedes vehicle.
An observation that the user did not return to Mercedes website after visiting the blog and rather chose to visit a website of a different brand of luxury car.
A recommendation to Mercedes on how to retain users in the website and increase conversions.
A recommendation to Mercedes to collaborate with luxury cars related blogs.

To obtain effective and substantiated value points for a certain use-case, many journeys (e.g., between thousands to millions) of many users, which are relevant to the use-case, should be identified and analyzed. However, this task poses various technological challenges.

To achieve this goal a relatively small portion of interactions relevant to the use-case (also referred to herein as “use-case related interactions”) must be identified and extracted from many teras (10¹²) of recorded users' activity that contains billions of interactions performed by millions of users all over the world. Furthermore, for high quality output it is advantageous to identify journeys which are sufficiently rich and contain sufficient information to provide a value to a client (e.g., in terms of length of journey, conversion cases and domains variance, etc.), informative (e.g., in terms of covered products and topics of interest) and accurate (e.g., in terms of percentage of false negative and false positive cases, as well as coverage rate), thus identifying the relevant information poses a significant challenge.

The specific characteristics of interaction data preclude the use of standard data processing techniques. As mentioned above, journeys are constructed from sequences of interactions (e.g., click-stream data) where the textual data recorded with respect to each interaction commonly includes a domain (also referred to as URL or domain-name) and time of the event (“creation time”) and often also a web page title. For example, the domain of “www.Amazon.com” is the word: “Amazon”. As neither URLs nor web page titles are “natural” human language constructs, standard off-the-shelf Natural Language Processing (NLP) Data Science and/or Machine Learning (ML) models or methods are inapplicable in this case.

Journeys (which may correspond to “targets”) are not well-defined from a data science perspective. Journeys may be of any length, may contain different fields of interest, different behavior patterns for the same purpose (e.g., different journeys which include an endless variety of combination of interactions, all for the same purpose) and may contain interactions in different languages. In addition, a conversion case (if exists) may appear at any step of a journey. Consequently, off-the-shelf machine learning (ML) packages where a target is learned given a set of features may provide poor or misleading results. Furthermore, annotation of any type is inapplicable in scale and inconsistent with a generic approach as a benchmark or ground truth that can be used for clearly defining interactions relevant to a certain use-case is unavailable. The basic data in interaction is extremely unbalanced and noisy. In some cases, of billions of interactions stored in a database, a set of journeys that contain around a million interactions for a given use-case should be detected. A huge amount of information is missing, especially in web page titles which are, in many cases, the most informative field. In such a setup, existing ML methods often fail to detect “true” cases and distinguish them from “false” cases with high accuracy rate.

The presently disclosed subject matter includes a computerized method and system dedicated for automatically identifying use-case related interactions and corresponding use-case related journeys. According to the disclosed technique journeys related to a specific use-case of interest are identified by applying predictors on a database of interactions. The predictors accurately define the use-case and are generated by a specially designed learning process, which does involve learning applied on the journeys themselves (targets). The disclosed technique is generic, as it can be applied to different use-cases in different industries and different countries or languages, without the need for adjustments or manual intervention. The disclosed technique is characterized by high accuracy and high coverage providing valuable output. The disclosed technique is designed to utilize minimal input setup to reduce manual effort and reduce time to delivery. In some examples, the method is executed in a fully automatic mode following minimal initial human input.

According to a first aspect of the presently disclosed subject matter there is provided a computer implemented method of detecting use-case related users' interactions from a computer database storing a corpus of interactions generated by many users, wherein a sequence of interactions performed by a specific user is indicative of a journey that is informative of user's online behavior, the method comprising:
obtaining a use-case description comprising a plurality of textual elements, which are related to the use-case and include at least a core domain and one other related domain; executing a predictors generation process comprising:
   for each interaction in a sample of interactions extracted from the database:
      evaluating the interaction to determine compliance with features, wherein each feature is defined based on one or more textual elements in the use-case description and is indicative of a correlation between the interaction and the use-case;
      determining a score for each interaction based on a respective aggregation of features;
   generating, based on the score of each interaction in the sample, a first subgroup of use-case related interactions (with particular relevance to the use-case) and a second subgroup of common interactions (without any particular relevance to the use case);
   comparing between textual elements associated with interactions in the first subgroup and textual elements associated with interactions in the second subgroup and identifying a group of non-overlapping textual elements;
   generating from textual elements in the group of non-overlapping textual
   1 elements a collection ofuse-case specific predictors (each being a textual element); and
applying the collection of predictors on a corpus of interactions for identifying use-case related interactions in the corpus.

In addition to the above features, the method according to this aspect of the presently disclosed subject matter can optionally comprise one or more of features (i) to (xii) below, in any technically possible combination or permutation:
I. Wherein each interaction stored in the database is associated with a respective domain.
II. The computer implemented method further comprising automatically generating the use-case description, comprising:
   obtaining a first collection of numerical vectors, each numerical vector representing a respective textual element extracted from the corpus of interactions, wherein textual elements extracted from the corpus of interactions are transformed into their respective numerical vector by a word embedding model that was trained on the corpus of interactions;
   obtaining a list of keywords (including domain-names, words, expressions) related to the use-case;
   identifying in the database interactions related to the domains in the list;
   generating a subset of use-case related textual elements that include the keywords in the list and words and expressions extracted from the relevant interaction;
   obtaining a second collection of numerical vectors that correspond to the subset of use-case related textual elements (generated for example by applying the word embedding model on the subset of use-case related textual elements);
   determining correlation between numerical vectors in the first collection and numerical vectors in the second collection, to thereby identify numerical vectors in the first collection that represent respective textual elements from the corpus of interactions which are contextually correlated to textual elements in the subset of use-case related textual elements; and
   generating a use-case description comprising the subset of use-case related textual elements and at least part of the respective textual elements from the corpus of interactions.
III. wherein automatically generating use-case description further comprises:
   determining similarity between numerical vectors of textual elements in the use-case description and numerical vectors in the first collection, to thereby determine whether there is at least one textual element in the use-case description which is contextually correlated with textual elements extracted from interactions stored in the database that are associated with a domain unrelated to a core domain of the use-case;
   if there is, defining the at least one textual element as a negative textual element that indicates negative correlation between the core use-case and an interaction that is associated with the negative textual element; and
   adding the negative textual element to the use-case description.
IV. wherein the list of keywords comprises at least a core use-case domain-name and at least one other related domain-name.
V. wherein the number of keywords in the list does not exceed one of the following values: 2; 3; 4; 5; 6; 7; 8; 9; 10; 11; 12; 13; 14; 15; 16; 17; 18; 19; and 20.
VI. The computer implemented method further comprising applying a consistency analysis comprising:
   obtaining a third collection of numerical vectors, each representing a respective textual element in the group of non-overlapping textual elements (e.g., by applying the word embedding model, on textual elements in the group of non-overlapping textual elements);
   obtaining a fourth collection of numerical vectors, each representing a respective textual element in the use-case description (e.g., by applying the word embedding model, on the keywords in the use-case description);
   determining similarity (e.g., cosine similarity) between numerical vectors in the third collection and numerical vectors in the fourth collection, to thereby identify numerical vectors in the third collection that represent textual elements which are contextually correlated with textual elements in the fourth collection; and
   selectively adding to the collection of predictors textual elements which exhibit contextual correlation with textual elements in the use-case description that is greater than a certain threshold value.
VII. The computer implemented method further comprising applying sematic correlation, comprising:
   obtaining a first group of numerical vectors that correspond to textual elements in the collection of predictors, generated by applying the word embedding model on textual elements in the collection of predictors;
   obtaining a second group of numerical vectors that correspond to textual elements in the group of non-overlapping textual elements (which have not yet been added to the collection of predictors), generated by applying the word embedding model on textual elements in the group of non-overlapping textual elements;
   determining similarity (e.g., cosine similarity) between numerical vectors in the first group and numerical vectors in the second; and to thereby identify numerical vectors in the second group that represent textual elements in the group of non-overlapping textual elements, which are contextually correlated with textual elements in the collection of predictors; and
   selectively adding to the collection of predictors textual elements from the group of non-overlapping textual elements which exhibit contextual correlation with textual elements in the collection of predictors that is greater than a certain threshold value.
VIII. Wherein generating from textual elements in the group of non-overlapping textual elements a collection of predictors comprises:
   assigning to each textual element in the group of non-overlapping textual elements a respective score indicative of its probability of being part of the first subgroup and not the second subgroup; and
   selectively adding to the collection of predictors textual elements from the group of non-overlapping textual elements that are assigned with a respective score which complies with one or more predefined conditions.
IX. Wherein applying the collection of predictors on the interactions in the database and identifying use-case related interactions further comprises:
   wherein each interaction is associated with a respective user giving rise to a respective group of user specific use-case related interactions;
   for each user, generating from the respective group of user specific use-case related interactions a user-journey, comprising:
   constructing a journey skeleton by distributing interactions from the group of user specific use-case related interactions along a timeline according to their respective time of creation.
X. Wherein applying the collection of predictors on the interactions in the database and identifying use-case related interactions, further comprises:
   for each interaction in the database:
   identifying predictors from the collection of predictors that are found in the interaction;
   calculating a respective score for the interaction based on the respective scores of the identified predictors;
   determining whether the interaction is use-case related according to the respective scores; and
constructing the journey skeleton using interactions selected according to their scores.
XI. Wherein the use-case description further comprises additional textual elements, which are related to an adjacent market or/and an adjacent topic;
   wherein the predictors generation process further comprises generating additional predictors, related to an adjacent market and/or an adjacent topic;
   applying the additional predictors for identifying additional interactions in the corpus related to the adjacent market and/or adjacent topic.
XII. The computer implemented method further comprising:
   enriching the journey by adding to the journey skeleton the additional interactions along a timeline according to their respective time of creation.

Additional aspects of the presently disclosed subject matter include:

A non-transitory computer readable storage medium tangibly embodying a program of instructions that, when executed by a computer, cause the computer to perform a method of detecting use-case related users' interactions in a computer database storing a corpus of interactions generated by many users, wherein a sequence of interactions performed by a specific user is indicative of a journey that is informative of user's online behavior, wherein the method comprises operations as disclosed above with respect to the first aspect.

A computer system comprising a processing circuitry comprising at least one processer and computer memory and operatively connected to a computer database comprising a corpus of interactions generated by many users, wherein a sequence of interactions performed by a specific user is indicative of a journey that is informative of user's online behavior, the processing circuitry is configured to execute a method of detection of use-case related users' interactions stored in the database; the method comprising operations as disclosed above with respect to the first aspect.

According to another aspect there is provided a computer product recorded on a non-transitory computer-readable medium for detecting use-case related users' interactions from a computer database storing a corpus of interactions, wherein each interaction stored in the database is associated with a respective domain and wherein a sequence of interactions performed by a specific user is indicative of a journey that is informative of user's online behavior, wherein the product incudes a use-case specific predictors package that can be applied on a corpus of interactions for identifying use-case related interactions in the corpus; the computer product is produced by a process comprising:
obtaining a use-case description comprising a plurality of textual elements, which are related to the use-case and include at least a core domain and one other related domain; executing a predictors generation process comprising:
   for each interaction in a sample of interactions extracted from the database:
      evaluating the interaction to determine compliance with features, wherein each feature is defined based on one or more textual elements in the use-case description and is indicative of a correlation between the interaction and the use-case;
      determining a score for each interaction based on a respective aggregation of features;
   generating, based on the score of each interaction in the sample, a first subgroup of use-case related interactions and a second subgroup of common interactions;
   comparing between textual elements associated with interactions in the first subgroup and textual elements associated with interactions in the second subgroup and identifying a group of non-overlapping textual elements;
   generating from textual elements in the group of non-overlapping textual elements the use-case specific predictors package.

The non-transitory program storage device, the system and the computer program product disclosed in accordance with the presently disclosed subject matter can optionally comprise one or more of features (i) to (xii) listed above, mutatis mutandis, in any technically possible combination or permutation.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a schematic illustration of a journey, in accordance with an example of the presently disclosed subject matter;

FIG. 2 is a block diagram illustrating a computer system, in accordance with an example of the presently disclosed subject matter;

FIG. 3 is a general flowchart illustrating operations carried out in accordance with an example of the presently disclosed subject matter;

FIG. 4 is a flowchart illustrating operations carried out during automatic generation of use-case description, in accordance with an example of the presently disclosed subject matter;

FIG. 5 is a flowchart of operations carried out during consistency analysis, in accordance with an example of the presently disclosed subject matter;

FIG. 6 is a flowchart of operations carried out during journey detection, in accordance with an example of the presently disclosed subject matter;

### DETAILED DESCRIPTION

In the drawings and descriptions set forth, identical reference numerals indicate those components that are common to different embodiments or configurations. Elements in the drawings are not necessarily drawn to scale.

Unless specifically stated otherwise, as apparent from the following discussions, it is appreciated that, throughout the specification, discussions utilizing terms such as “obtaining”, “evaluating”, “determining”, “generating”, “applying”, “identifying”, “comparing” or the like, include an action and/or processes of a computer that manipulate and/or transform data into other data, said data represented as physical quantities, e.g. such as electronic quantities, and/or said data representing the physical objects.

The terms “computer”, “computer device”, “computer system” or the like, should be expansively construed to include any kind of hardware-based electronic device with at least one processing circuitry (e.g., digital signal processor (DSP), a GPU, a TPU, a field programmable gate array (FPGA), an application specific integrated circuit (ASIC), microcontroller, microprocessor etc.). The processing circuitry can comprise, for example, one or more processors operatively connected to computer memory, loaded with executable instructions for executing operations as further described below.

Operations in accordance with the teachings herein may be performed by a computer specially constructed for the desired purposes, or by a general-purpose computer specially configured for the desired purpose by a computer program stored in a computer readable storage medium.

As used herein, the phrase “for example,” “such as”, “for instance” and variants thereof, describe non-limiting embodiments of the presently disclosed subject matter. Reference in the specification to “one case”, “some cases”, “other cases”, or variants thereof, means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately, or in any suitable sub-combination.

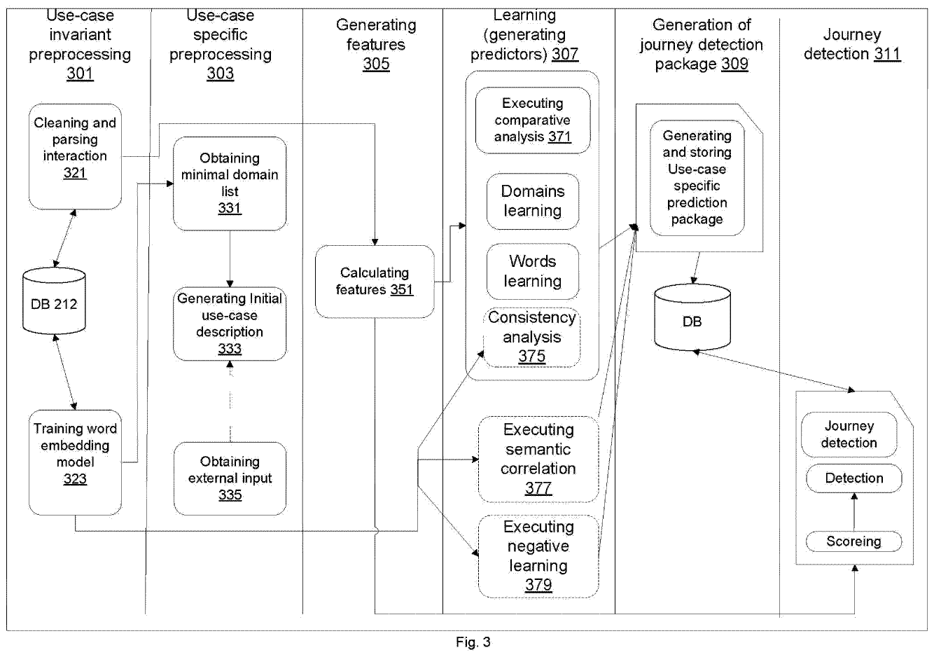

In embodiments of the presently disclosed subject matter, fewer, more and/or different stages than those shown in FIGS. 3 to 6 may be executed. In embodiments of the presently disclosed subject matter, one or more stages illustrated figures may be executed in a different order, and/or one or more groups of stages may be executed simultaneously.

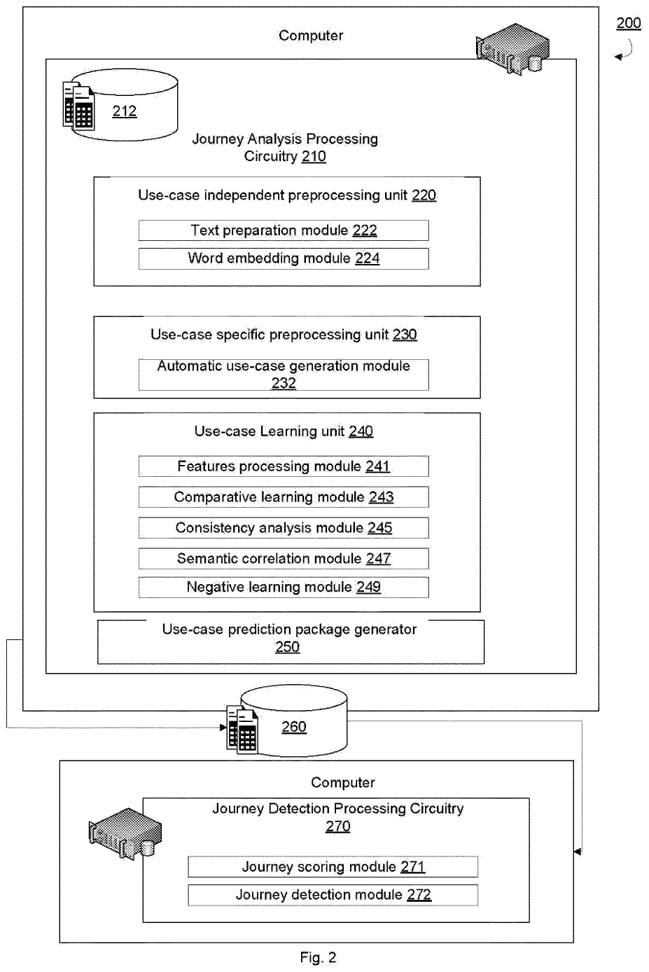

FIG. 2 illustrates a general schematic of a computer system architecture in accordance with certain examples of the presently disclosed subject matter. Elements in FIG. 2 can be made up of any suitable combination of software and hardware and/or firmware that performs the functions as defined and explained herein. In examples of the presently disclosed subject matter, other than what is illustrated, the system may comprise fewer, more, and/or different elements than those shown in FIG. 2. For example, FIG. 2 shows computer system 200 that comprises two computers each comprising a respective processing circuitry while it should be clear to any person skilled in the art that a different number of computers (e.g., one computer or three computers), each possibly comprising a plurality of processing circuitries, can be used instead. Likewise, the division of the functionality of the disclosed system to specific parts as described below with reference to FIG. 2, is provided by way of example, and other various alternatives are also construed within the scope of the presently disclosed subject matter. In some examples, system 200 may be implemented by a plurality of computer devices interconnected over some type of communication network. For example, communication can be realized over any one of the following networks: the Internet, a local area network (LAN), wide area network (WAN), metropolitan area network (MAN), any type of telephone network (for example PSTN with DSL technology) or mobile network (for example 4G or 5G mobile communication technologies), or any combination thereof.

Bearing the above in mind, attention is drawn to FIG. 2, which is a block diagram of a computer system, according to some examples of the presently disclosed subject matter. The system architecture in FIG. 2 is a general example which demonstrates some principles of the presently disclosed subject matter where in practice it may vary in structure and/or design and therefore should not be construed as limiting.

As an initial step, the method may be initiated by receiving a use-case. The use-case may be input by a user, where the user may be a human user or a machine user, e.g. a bot.

According to the illustrated example, computer system 200 comprises a journey analysis processing circuitry 210 and journey detection processing circuitry 270. Journey analysis processing circuitry 210 is operatively connected to an interactions-database 212 and is configured to obtain a use-case description, as explained below. In summary, the method may further comprise constructing a use-case description using at least some of the plurality of textual elements and the received use-case. In some examples, Journey analysis processing circuitry 210 is configured to automatically generate a use-case description using data obtained from the interactions stored in the interactions-database. The use-case description is then used for generating a collection of predictors (“use-case specific predictors package”) that provide an extended data-driven use-case definition and can be used for identifying use-case related interactions and corresponding journeys in an accurate and efficient manner.

Journey detection processing circuitry 270 is configured to apply the predictors on a corpus of interactions and detect use-case related interactions and corresponding journeys. System 200 can further comprise various input devices (not shown) such as keyboard, touch screen, mouse, etc. as well as one or more display devices to enable interaction of users with the system. Each processing circuitry in system 200 can comprise one or more computer processors operatively connected to a computer storage medium. The processing circuitries can be configured to execute modules in accordance with computer-readable instructions implemented on a non-transitory computer-readable storage medium. For simplicity, such modules are referred to hereinafter as components of the processing circuitry. A more detailed description of the operations of 200 is disclosed below with reference to the following figures.

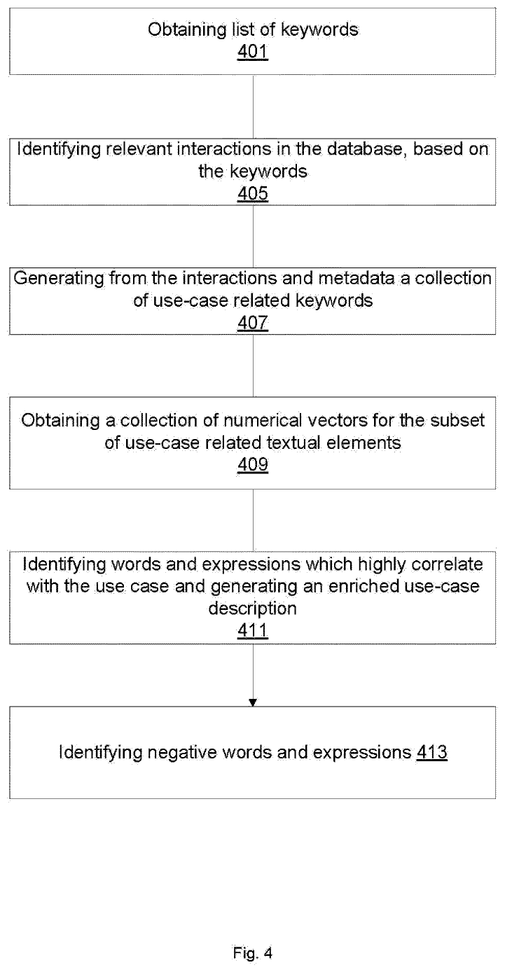

Turning to FIG. 3 it shows a general flowchart of operations carried out, according to some examples of the presently disclosed subject matter. For example, FIG. 3 relates to a computer-implemented method of constructing a journey from a plurality of interactions. Operations in FIG. 3, (as well as FIGS. 4 to 6 below) are described with reference to corresponding elements which are illustrated in FIG. 2. However, this is done by way of example only and should not be construed to limit the scope of the presently disclosed subject matter to the specific components and/or design exemplified in FIG. 2.

At block 301 use-case invariant preliminary data processing is executed (e.g., by use-case independent preprocessing unit 220 in system 200). This includes operations which are performed on interactions stored in interactions-database 212 and are not dependent on any specific use-case. Users' interactions are normally recorded by web browser as they occur. System 200 comprises or is otherwise operatively connected to interactions-database 212, which is used for storing many different interactions (e.g., teras or more) collected and recorded from various resources over time. In some examples, the database is being continuously updated and may continuously increase in size as more interactions are being added to the database. Interactions-database can be implemented using a computer data storage device of some sort. In this way, the method comprises receiving a plurality of interactions from an interactions-database 212.

Operations performed as part of the invariant preliminary data processing include, for example, cleaning and parsing the interactions' URLs and titles, adding metadata, and properly arranging the data in the database (block 321; e.g., by text preparation module 222). In some examples, recorded URLs are parsed and cleaned such that the final strings which are being stored in the database include only significant textual elements. In this way, the method comprises obtaining a plurality of textual elements for each interaction of the plurality of interactions. For example:
URL: https://www.amazon.com/AfterShokz-Wireless-Conduction-Bluetooth-Headphones/dp/B014G6ZJFO/ref=sr_1_15?crid=3MAI38CSXMBIQ&keywords=afte rshockz+headphones&qid=1557172502&s=gateway&sprefix=aftersho %2Caps %2C1 78&sr=8-15
will be transferred into a list of significant words:
amazon; aftershokz; wireless; conduction; Bluetooth; headphones; aftershokz; headphones; gateway; afersho;

All titles are cleaned by removal of insignificant words and symbols, numbers and punctuation. For example, procedure for removing “domain stopwords”—common words in e-activities and e-consuming, can be used. In this way, obtaining the plurality of textual elements from each interaction may comprise cleaning the interaction to identify the textual elements, and obtaining a vector for each identified textual element.

In some examples, words and expressions extracted from each URL of each interaction are stored together (e.g., in a single record) with other information obtained with the interaction including: the domain-name, time of creation, and title, if available. Other metadata, e.g., related country, keywords that describe the relevant topic, information about related topics, can be added to the data stored with respect to the interaction.

Use-case invariant preliminary data processing also includes training a word embedding model that allows to find relations between different textual elements, including domains, words and expressions which are stored in the interactions-database, based on their context (block 323; e.g., by word embedding module 224). According to word embeddings methods, individual words are represented as real-valued vectors in a predefined vector space. Each word is mapped to a respective vector, where mapping of words to vectors is learned based on word usage in the corpus used for training. The resulting vectors preserve the contextual association such that words which are more closely related in context also have closer numeric representation. Here, data stored in the interaction database, including textual elements extracted from interactions (including domain-names, words, and expressions) and metadata, is used as the training corpus of the word embedding model providing numerical vector representation of the text. In some examples, interactions stored in the database are classified according to their respective country and the training can be applied on interactions classified to different countries individually. In some examples, the training corpus is generated from a sample created from “high quality” interactions selectively extracted from the interaction-database that are characterized by many events and many textual elements (e.g., above a certain value determined based on analysis of all interactions in the database). Notably, the training corpus of a certain country may contain interactions in different languages, however, since the training corpus is not a natural language text and is constructed from a sufficiently large number of “high quality” interactions, contextual correlation between words in different languages found in data from a certain country can be identified without affecting correlation accuracy.

Different word embedding methods applying different algorithms may be used to create the word embedding model, including any one of neural network methodologies or some combination thereof, such as: Word2vec, BERT (Bidirectional Encoder Representations from Transformers), Gloves (Global Vectors for Word Representation), etc.

At block 303 use-case specific preliminary data-processing is executed. This includes generating a use-case description. A use-case description defines the specific use-case and can be provided, for example, as a collection of textual elements (including domains, words and expressions) which are related to the use-case. The use-case description is a basic description that serves as a starting point for automatic generation of data-driven predictors which are used for identifying use-case related interactions and corresponding journeys as further explained below.

A use-case description can include, by way of example at least part of the following data: a core domain and other related domains, set of other keywords, brands/products of interest, additional information about complementary markets, relevant blogs, and forums, etc. The core domain is a name of a main website which provides a basis of the use-case description. For example, a core domain can be the name of a website of a client for whom the analysis is being performed (e.g., www.Toyota.com). The related domains are websites which are related to the core domain, for example names of websites of companies that deal with the same line of business. In case the core domain is a client's domain, related domains can be for example, domains of client's competitors.

In some examples, a use-case description is obtained from an external source (block 335). For example, a use-case description can be generated manually by a data-analyst, who manually assembles a collection of domain-names, words and expressions which are related to a specific use-case. In some examples the text in the use-case description is parsed and cleaned, and a lemmatization algorithm is applied on the text to enrich the text with all possible inflects (single and plural forms etc.).

Alternatively, a use-case description can be automatically generated. To this end, the presently disclosed subject matter includes a computer-implemented automatic learning process configured to generate a use-case description based on minimal user input. Automatic generation of the use-case description facilitates an end-to-end use-case specific journey detection process with minimal or no manual user-interaction with the system. According to this approach a short (e.g., minimal) list of keywords is provided as input to system 200 (block 331), which is configured to automatically generate a use-case description (block 333).

The list can include for example, core-domain-name (e.g., client's website) and related domain-names (e.g., competitors' websites). A detailed description of operations carried out during automatic generation of a data-driven use-case description is provided below with reference to FIG. 4. Operations described with reference to block 303 can be executed, for example by use-case specific preprocessing unit 230 in system 200. In some examples, use-case specific preprocessing unit 230 includes automatic use-case generation module 232 configured to automatically generate a use-case description as further described below with reference to FIG. 4. The use-case generation module may be a language model. In this way, constructing the use case may be done using a language model.

Turning to FIG. 4, it shows a flowchart of operations carried out during automatic generation of a use-case description, according to some examples of the presently disclosed subject matter.

A short list of keywords related to the use case are obtained, e.g., as input provided by a user to system 200 via an application or web user-interface (block 401) and the keywords are used for identifying and retrieving relevant interaction from the database (block 405). If the list includes domain-names, the relevant domains are identified in the interactions-database by their domain-name (212) and Interactions recorded on the identified domains (i.e., events that occurred while interacting with the domain) are retrieved from the database. If the list includes textual elements other than domain-names, the textual elements can be used for identifying relevant domains (e.g., keyword “life insurance” can be used for identifying life insurance domains), which can be identified in the interactions-database based on metadata. In some examples, URLs of the core-domain (e.g., client's website) and one or more related domains (e.g., competitors' websites) are provided as input. The URLs are parsed and cleaned, and the domain-names are extracted from them. A minimal list may include as little as two domains (e.g., a client's domain and a competitor's domain). The number of textual elements (denoted by N) in the list may be in some cases limited not to exceed a certain number, e.g., N<5 or N<8 or N<10 or N<12 or N<15 or N<20; etc. in this way, the method may comprises limiting a number of textual elements in the minimal list of textual elements to a predetermined number of textual element. The predetermined number of textual elements may be 5, 10, 15, 2o, of any number corresponding to the certain number defined above.

Words and expressions which are associated in the database with the retrieved interactions are extracted (possibly along with relevant metadata) from the database to form a group of textual elements. The most frequent and/or significant words and expressions are extracted from the group of textual elements forming together with the domain names, a selected subset of use-case related textual elements (block 407). Significance in this case can be determined in various methods, for example words that appear in 90% or more of the interactions are considered significant even if their frequency is smaller than average.

A collection of numerical vectors, each representing a respective word or expression in the subset of use-case related textual elements. This can be achieved for example, by applying the word embedding model, which has been applied on the textual elements in the interaction-database, on the textual elements in the subset (block 409). As explained above, the generated vectors preserve the contextual association such that words which are more closely related in context also have closer numeric representation.

Statistical methods are applied for comparing the collection of numerical vectors generated from the use-case description (the selected subset of use-case related textual elements) and the numerical vectors generated from the interactions-database to identify vectors that represent words and expressions in the interactions-database, which exhibit high correlation with word and expressions found in the use-case description (block 411). For example, this could be achieved by determining the average correlation between vectors representing domain-names, words and expressions obtained from the interactions-database and the vectors representing words and expressions obtained from the subset of use-case related textual elements. Correlation can be determined using for example Cosine similarity. A proximity threshold can be defined for individual vectors (e.g., based on standard deviation values) and textual elements which show similarity above threshold are added to the use-case description. Words and expressions found in the interactions-database which are identified to have high correlation with the textual elements found in the selected subset of use-case related textual elements are added to the use-case description.

In other words, the method comprises obtaining at least one vector for the use-case, which may mean obtaining a vector for each textual element (e.g. a keyword or domain) of the use-case, calculating a distance between the at least one vector for the use-case and the vector for each identified textual element, comparing each distance to a proximity threshold, and constructing a minimal list of textual elements based on the comparison. Constructing the use-case description using at least some of the plurality of textual elements and the received use-case comprises constructing the use-case description using the minimal list of textual elements and the received use-case. Constructing the minimal list of textual elements based on the comparisons comprises discarding any textual elements having a distance greater than or equal to the proximity threshold, and retaining any textual elements having a distance less than the proximity threshold.

In some examples, negative textual elements are also identified and added to the use-case description (block 413). Negative textual elements include words and/or expressions which exhibit high correlation to related domains (e.g., client's and competitors' websites) but also to other domains which are not related to the use-case. Negative textual elements found in interactions indicate negative correlation between the interactions and the use-case. For example, considering a use-case related to car purchase, the name “Lincoln” may be found to be related to the core-domain but also to other totally unrelated domains in different contexts such as Lincoln Street or Lincoln memorial. Word and expressions found in the interactions-database which show correlation (e.g., above some threshold) with the words and expressions in the use-case description and also show correlation (above some threshold) to at least one other unrelated areas of interest are identified as negative words. Again, in some examples this is done with the help of statistical methods applied on numerical vectors obtained by applying the word embedding model on the different textual elements. For example, an embedding is obtained for the use-case description and an embedding is obtained for the words in the interaction, and a distance is computed between the two, e.g. cosine similarity or similar. Please confirm if this is accurate. As mentioned above, interactions are associated with meta-data that describes the related field or topic. This meta-data can be used for determining that a certain word or expression is related to an interaction that is associated with a domain that is unrelated to the core domain of the use-case. Negative textual elements contribute to the reduction of false positive detection of use-case related interactions in the sample. In this way, the method comprises obtaining meta-data of each interaction associated with the retained textual elements, determining if the retained textual elements are associated with a use-case unrelated to the received use-case, and discarding any retained textual elements that are determined to be associated with the use-case unrelated to the received use-case.

The above process enables to automatically generate, starting from a small number of textual elements, (e.g., two domain-names), a data-driven use-case description which comprises a collection of domains, words and/or expressions which are highly related to the use-case and provide a detailed and accurate definition of the use-case.

It is noted that a system capable of receiving a minimal list of keywords (e.g., client's domain and some restricted number of competitors domains) as the only input and automatically generating from this minimal input a use-case description provides a significant technological improvement. Such a system obviates the need for a detailed use-case description generated by a skilled data analyst, in process which is often time consuming and complicated, and allows any user, with basic computer skills, to initiate a use-case related journey detection process with very little effort.

Reverting to FIG. 3, once the use-case description is available, it can be used in the learning procedure described below with reference to blocks 305 to 309. During the learning procedure, processing is applied on interactions stored in database 212 for the purpose of identifying a collection of predictors which have high correlation with the use-case and can be used for identifying use-case related interactions. Operations related to the learning procedure can be performed for example by use-case learning unit 240 in system 200.

The learning procedure includes the division of a data sample into a use-case related subgroup and common subgroup and identification of candidates by crossing between the two subgroups. The is a new approach fundamentally different from commonly used approaches which involve machine learning and data science methods and is tailored to match the special characteristics of interactions and journeys as discussed above.

To overcome possible processing bottleneck, in some examples, a sample of interactions is extracted from the interactions-database and used during the learning procedure rather than the entire data. Interactions can be added to the sample based on various parameters which can be predefined. These parameters can include for example one or mor of the following: relevant country of interest (e.g., defined by the use-case description), time/date of creation (e.g., if identifying journeys within a period is desired), the appearance of certain expressions in the interactions which indicate possible relation to the use-case, interactions of specific users characterized by a relatively large overall number of interactions, etc.

Block 305 (more specifically 351) refers to the calculation of a collection of features, defined based on the use-case description. Each feature corresponds to one or more traits defined according to one or more textual elements in the use-case description and indicative of the correlation with the use-case. In other words, a feature is an attribute derived from the interaction data, represented as a numerical value or vector indicating the presence, frequency, or strength of a specific signal used by the algorithm.

Each interaction in the sample is evaluated to determine whether it complies with the features and a respective score is assigned to the interaction according to the aggregated compliance with features. The collection of features may include positive features which positively indicate correlation with the use-case and negative features which indicate lack of correlation with the use-case.

The following is a non-limiting list of examples of features:
whether the domain of the interaction appears in the list of domains found in use-case description; whether the words and/or expression extracted from the interaction's URL appears in the use-case description; whether the words and/or expression extracted from the interaction's title appears in the use-case description; whether the interaction's title or URL comprise a specific type of word or expression that appears in the use-case description, for example, whether the interaction includes a certain brand name that appears in the use-case description; whether the interaction includes a negative word, which provides a negative indication of correlation to the use-case; etc.

In this way, the method may comprise identifying a plurality of features associated with the use-case, the plurality of features defining a degree of correlation between the respective interaction of the use-case.

The features are used for classifying interactions in the sample into two subgroups, where interactions associated with an aggregated score which indicates significant correlation to the use-case are assigned to the first subgroup (also referred to herein as “use-case related subgroup”) and interactions associated with an aggregated score which does not indicate a significant correlation with the use-case are assigned to the second subgroup (also referred to herein as “common subgroup”). In some examples, each feature that positively supports the correlation of an interaction with the use-case increments the score (e.g., by 1) if the interaction is characterized by this feature. Likewise, in some examples, each feature that negatively supports the correlation of an interaction with the use-case decrements the score (e.g., by 1) if the interaction is characterized by this feature. Features from different categories of features are converted into numerical values (which may be binary, signed, or weighted), aggregated into an aggregated score for the interaction, and this aggregate score is compared to a threshold to determine the appropriate interaction sub-group.

Notably, in some examples, features associated with negative words can positively contribute to the aggregated score if the negative word is missing from interaction (i.e., the feature being “negative word x does not appear in interaction”) and/or negatively contribute to the aggregated score if the negative word appears in the interaction. Operations related to the generation of features and of the two subgroups can be performed, for example, by features processing module 241. In this way, the method may comprise calculating an aggregate score for each interaction based on the features.

Following generation of the two subgroups of interactions, further processing (learning) is applied on the subgroups to identify a collection of predictors, also refer to herein as “use-case specific predictors package” (block 307). In other words, the method may comprise identifying a set of candidate predictors as a predictors package. Predictors enrich the initial use-case description and include, in addition to the textual elements found in the use-case description additional domain-names, words and expressions which have strong correlation with a specific use-case and therefore their existence in an interaction can serve to indicate that the interaction is use-case related. Examples of different types of predictors include:
domains highly correlated with a core use-case of interest such as competitor's websites (in additional to those found in the use-case description), related forums, blogs, etc.); domains weakly correlated with a use-case of; words and expressions (of any length) that describe a core use-case (in additional to those found in the use-case description); negative words; etc.

As mentioned above, features are used for classifying interactions into two subgroups, a use-case related subgroup and common subgroup of interactions which are not particularly relevant to the use-case. In some examples, a certain threshold is defined where each interaction is scored according to its respective aggregated features. Interactions with a score greater than the threshold value are assigned to the first subgroup, interactions with a score that equals 0 are assigned to the second subgroup and interaction with a score that is greater than 0 and smaller than the threshold value are discarded. In this way, the method may comprise comparing the aggregate score for each interaction to an aggregate score threshold, and identifying interactions relating to the use-case as interactions having an aggregate score greater than or equal to the aggregate score threshold and identifying the commonly occurring interactions as interactions having an aggregate score below the aggregate score threshold. This approach ensures that only the most relevant interactions are added to the first subgroup and the most irrelevant interactions are added to the second subgroup.

Following generation of the two subgroups, comparative analysis is applied on the two subgroups (block 371; executed for example by comparative learning module 243 illustrated as part of use-case learning unit 240), where textual elements extracted from the interactions in the first subgroup are compared to textual elements extracted from interactions in the second subgroup, and non-overlapping textual elements are identified as candidate predictors. In this way, the method may comprise identifying a plurality of textual elements from the plurality of interactions as candidate predictors. As above, this may comprise identifying interactions related to the use-case (first subgroup) and commonly occurring interactions (second subgroup) using the associated textual elements and the use-case, identifying non-overlapping textual elements from the interactions related to the use-case and the commonly occurring interactions (i.e. between the two subgroups), and obtaining the candidate predictors as the non-overlapping textual elements. The term “non-overlapping text” is used herein to include textual elements such as domain-names, words and expressions that are frequent and/or significant in the use-case related subgroup and rare (or absent) and/or insignificant in the common group.

Statistical method are applied on textual elements in each subgroup and the textual elements are scored and those with a score above threshold are identified as significant. The threshold value can be determined for example, by running simulations on a training subset of interactions and identifying a threshold that indicates significance. This approach enables to identify textual elements that show high correlation with the use case and low or no correlation with other unrelated topics and generate from these textual elements a pool of candidate predictors which accurately define the specific use-case with low probability of false positives.

Different statistical methods can be used for assigning to each textual element a respective score (“probability score”). The probability score may define a probability that the textual element is unique to the use-case. Such statistical methods include for example:
1. Probability-based approach:

P(w∈use−case related subgroup)→1, and P(w∈common group)→0

Identifying candidate predictors as words, expression and/or domains (w) with high probability (e.g., P above a certain threshold. say, P>80%) of being unique to the case related subgroup and rare (or absent) in the common group (e.g., subject to consistency analysis described below).
2. Likelihood-based approach:
Analysis of l where:

$${l}_{w} = \frac{{L}_{w} ( use - case )}{{L}_{w} ( common )}$$

Identifying candidate predictors as words, expressions and/or domains (w) with high ratio (e.g., l_{w} above a certain threshold, say l_{w}>80%) between likelihood L_{w}(use−case) of being in use-case group and likelihood L_{w}(common) of being in control group. Likelihood function depends on a distribution of words in the corpus. A word (w) is identified as a candidate predictor if the calculated ratio complies with some threshold value (e.g., subject to consistency analysis).
3. Odd ratio-based approach. This approach is similar to the previous approach and includes comparing odds ratios (probability to be in use-case group). An odds ratio is a statistical method that quantifies the strength of the association between two events, A and B. The odds ratio is defined as the ratio of the odds of A in the presence of B and the odds of A in the absence of B. Define A: “word appears in a use-case group” and B: “word appears in common group”. Odds is a measure of likelihood of a particular output. Words, expressions and/or domains with odds ratio above a pre-defined threshold are identified as candidate predictors.
4. other approaches such as tree-based estimation, clustering, etc.

After the candidate predictors are identified, part or all of the candidate predictors can be added to the final collection of predictors (“use-case specific predictors package”).

According to some examples the following processing is applied for selecting domains and words and/or expressions from the pool of candidate predictors to be added to the predictors package.

### Domain-Name Learning:

Following detection of domain-names as candidate predictors (also referred to herein as “candidate domain predictors”) they are further processed, where candidate domain predictors are assigned to different subsets of predictors based on their respective probability scores. Candidate domain predictors with the highest scores (e.g., having a score above some predefined threshold, which may be a probability threshold) are designated as use-case domain predictors (i.e., first-degree correlation to use-case), candidate domain predictors with medium scores (e.g., score below the first threshold and above a second threshold lower than the first) are designated as second-degree use-case domain predictors (i.e., second-degree correlation to use-case). Other candidate domain predictors with lower scores are discarded. In other words, identifying a set of candidate predictors as a predictors package may comprise calculating a probability score for each textual element in the candidate predictors, and identifying the set of candidate predictors based on the respective probability score. This may be achieved by comparing the respective probability score to a probability threshold, retaining textual elements having a probability score greater than or equal to the probability threshold in the set of candidate predictors, and discarding textual elements having a probability score less than the probability threshold.

### Word/Expression Learning:

Following detection of words and/or expression as candidate predictors (also referred to herein as “candidate words and expressions predictors”), they are further processed, where candidate words and expressions predictors are assigned to different subsets of predictors according to their respective probability scores. Candidate words and expressions predictors with the highest scores (e.g., having a score above some predefined threshold) are designated as use-case words and expressions predictors (i.e., first-degree relation to use-case) and added to the use-case specific predictors package, and all other candidate words and expressions predictors are discarded.

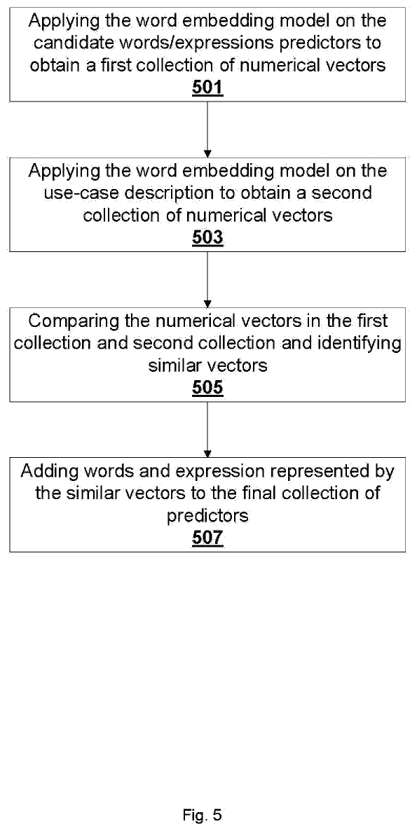

According to some examples additional operations are performed as part of the learning step (block 307) to enhance the quality of the use-case specific predictors package. This includes consistency analysis (block 375; executed for example by consistency analysis module 245). Consistency analysis is described with reference to FIG. 5 and includes applying the word embedding model on the candidate words and expressions predictors and on the textual elements in the initial use-case description (generated manually or automatically as described above) to obtain the respective numerical vectors (blocks 501 and 503). The vectors generated from these two groups are compared and vectors that show significant similarity (e.g., cosine similarity above a certain value) are identified (block 505). The corresponding candidate words and expressions of vectors identified as having significant similarity are added to the use-case specific predictors package (block 507). As explained above with respect to block 411 in FIG. 4, statistical methods are applied for comparing between the numerical vectors generated from the use-case description and the numerical vectors generated from the candidate words and expressions to identify vectors that represent candidate words and expressions, which are most highly correlated with vectors generated from the use-case description. According to some examples, only words and expressions that pass the consistency analysis are added to the use-case specific predictors package. In some cases, consistency analysis is a default requirement.

According to further examples, the additional operations performed as part of the learning step (block 307) to enhance the quality of the use-case specific predictors package may include further semantic correlation (block 377; executed for example by consistency analysis module 247). According to semantic correlation approach, words and expressions that are added to the final package of predictors (e.g., based on their probability score and compliance with the consistency test) are used as reference for identifying additional predictors. Considering that the processing of the candidate predictors may be done as iterative process, after the first few predictors are added to the use-case specific predictors package, vectors generated by the word embedding model are used for comparing between the words and expressions that were added to the package and words and expressions that are still in the pool of candidate predictors. If necessary, the word embedding model is applied for obtaining the corresponding numerical vectors. The vectors generated from these two groups are compared and vectors that show significant similarity (e.g., cosine similarity above a certain value) are identified and added to the use-case specific predictors package. Thus, the semantic correlation provides an alternative approach for enriching the use-case specific predictors package with textual elements that may not pass the probability threshold.

According to some examples, in addition to identifying predictors that have a positive correlation with the use-case, negative predictors that have negative correlation with the use-case are also identified (“negative learning”; block 379). An initial collection of one or more negative words is provided as input to the system. The word embedding model is applied to the collection of negative words to thereby identify other negative words which appear in the relevant corpus of interactions. As explained above, statistical methods are applied for comparing between the numerical vectors generated by the word embedding model from the textual elements of interactions stored in the interaction-database and the numerical vectors generated from the initial collection of negative words. Words and expressions found in the interactions which show highest correlation with words in the initial collection of negative words are added as negative predictors and assigned with respective scores. The negative words serve as negative signals which indicate, during the journey detection process, weak correlation between interactions that include such words and the use-case. Negative words identification can be executed for example, by negative words learning module 249 illustrated as part of use-case learning unit 240.

Thus far, the description of operations related to blocks 303 to 309 was made with respect to a use-case representing a main area of interest or topic, which is being examined (referred to hereinbelow as “core use-case”). The use-case description of the core use-case includes domains and other words and expression which describe or are otherwise directly related to the core use-case. In some examples, these operations are also executed with respect to other related areas of interest. Related areas of interest include for example, related (aka “adjacent” or “complementary”) markets and related (or “adjacent”) topics. Adjacent markets refer to complementary areas of interest which are different from the core use-case but directly related to it. For example, assuming the core-use case is related to luxury vehicle purchase domain, adjacent markets domains include websites about vehicle parts and vehicle rentals. Adjacent topics refer to websites that are not directly related to the core use-case but may publish information that is relevant to the core use-case. In the examples of luxury vehicle purchase, adjacent topics include publications on traffic accidences with luxury cars, publications on vehicles recalls etc. The process described above with respect to FIG. 3 can be executed for the core use-case as well as for the related areas of interest (e.g., one or more adjacent markets and one or more adjacent topics). As explained above with respect to the core use-case, the process starts by obtaining use-case descriptions that define an adjacent market and adjacent topic, respectively.

In case of an adjacent market and/or adjacent topic, the process starts from a description that defines the adjacent market and/or adjacent topic (like the use-case description described above). As in the core use-case the relevant description can be generated automatically by providing to the system a minimal list of domains. For example, automatic use-case generation module 232 can be further configured to receive a minimal list of domains and automatically generate the respective description for adjacent markets and/or adjacent topics.

Notably, for simplicity the term “use-case description” can be used to broadly refer to a collection of textual elements that includes textual elements related to the core use-case and that may also include textual elements related to other related areas of interest such as adjacent market and/or an adjacent topic.

Once a description of an adjacent market or adjacent topics is available a corresponding collection of predictors can be generated (e.g., adjacent market predictors package or adjacent topic predictors package) by following the steps described above in detail with reference to FIG. 3. This includes, for each adjacent market and/or adjacent topic: evaluating the interactions to determine compliance with the features; generating, based on the features, a first subgroup of related interactions and a second subgroup of unrelated interactions; identifying a respective group of non-overlapping textual elements; and generating a respective collection of predictors.

Thus, in some examples, the final output added to the use-case specific predictors package includes a first collection of core use-case predictors and one or more additional collections of predictors. The additional collections can include, for example, a second collection of adjacent market predictors and a third collection of adjacent topics predictors.

Examples of predictors generated for adjacent use cases and adjacent topics include:
domains correlated with adjacent markets; domains correlated with adjacent topics; words and expressions (of any length) that are correlated (e.g., describe) adjacent market; words and expressions (of any length) that are correlated (e.g., describe) adjacent topics; etc.

The additional collections of predictors are used during generation of a journey to identify interactions which are related to the use-case, in addition to those identified by the predictors of the core use-case. The additional interactions can be used for enriching the journey to enable to obtain from the journey analysis, more accurate and more diverse insights.

The resulting use-case specific predictors package may include in some examples the following predictors:
For the core use-case:
   i. use-case domain predictors (first-degree relation to use-case);
   ii. second-degree domain-name predictors;
   iii. use-case words and/or expression predictors; and
   iv. and negative predictors.
b. For the adjacent markets (e.g., adjacent markets):
   i. adjacent market domain predictors; and
   ii. adjacent market words and/or expression predictors.
c. For the adjacent topics:
   i. adjacent topic domain predictors; and
   ii. adjacent topic words and/or expression predictors.

As mentioned above, each predictor is stored together with data including: its type (e.g., core use-case, adjacent market and adjacent topic, negative), the core-use case to which it is related and a score indicating its level of correlation to the use-case.

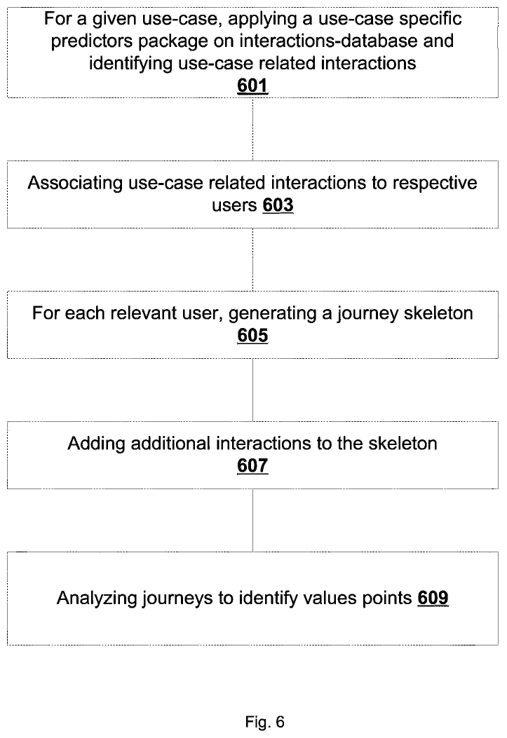

The collections of predictors (“use-case specific predictors package”) can be stored in a database (e.g., interactions-database 121 or some other designated database), where each predictor can be indexed and associated with data characterizing the descriptor including information identifying the related areas of interest, the type of descriptor, and one or more scoring matrixes indicating how the predictor supports the correlation between the interaction and the use-case. Once available, the use-case specific predictors package can be applied on any corpus of interactions for identifying use-case related interactions and corresponding journeys (block 311). A use-case specific predictors package can be repeatedly used for detecting journeys, until the interaction data used during training becomes insufficient or obsolete. A description of use-case related journeys detection procedure is described with reference to FIG. 6.

Turning to FIG. 6, it is a flowchart of operations carried out for detecting journeys, according to some examples of the presently disclosed subject matter. In some examples, operations described with reference to FIG. 6 can be executed by journey detection processing circuitry 270.

Data indicative of certain use case is received by journey detection processing circuitry 270. In some examples, journey detection is executed immediately after the generation of use-case specific predictors package as a unified process where a use-case description (e.g., minimal use-case description) is received and used for generating the predictors package which is then used for identified use-case related journeys. Alternatively, assuming for example, that several use-case specific predictors packages are available a user can select a certain use-case from a list and the respective use-case specific predictors package is selected and used by the system.

The use-case specific predictors package is applied to the database of interactions and use-case related interactions are identified (601). Notably, unlike in the learning procedure above, where only a sample of data may have been used for creating the use-case specific predictors package, here use-case specific predictors package is generally applied on the entire available data.

Recall that each predictor is assigned with a respective probability score, the predictors package is used for scoring each interaction with an interaction score, where each interaction is processed to determine which of the predictors are identified and a score is calculated for the interaction according to the respective scores of predictors which are identified in the interaction. In some examples, the scoring formula is not linear to increase distinguishing accuracy. In other words, the method comprises calculating an interaction score for each interaction of the plurality of interactions in the interactions database based on a correlation between the textual elements and the use-case. An exemplary formula is:

scoreⱼ=s(dj)+1.5^{Σw}^{ⱼ} Eq 1.
where s(dj) is a score assigned to a domain of interaction j, and ΣWⱼ denotes a sum of scores (e.g. probability scores) of related words or expressions found in interaction j. The score s(dj) may be generated by the algorithm based on characteristics of the domain and its observed behavior within aggregated user journey data.

In this way, calculating the interaction score for each interaction of the plurality of interactions in the interaction database based on the associated textual elements. More specifically, this comprises calculating the interaction score for each interaction based on the textual elements in the predictors package. In more detail, this may comprise calculating the interaction score using the calculated probability score for textual elements associated with the respective interaction.

In some examples, interactions that comprise negative predictors are excluded from the data, as well as noise (interaction with score=1).

Since the purpose of this process is to identify use-case related journeys, interactions of each user are processed independently to identify journeys performed by the user (block 603). For each user, interactions with a score above threshold are considered relevant to the use-case (“use-case related”) and analyzed to determine a respective journey. Each interaction is associated with a respective user giving rise to a respective group of user specific use-case related interactions which are further processed for generating the journey. In some examples, users that are found to have a sufficient number of use-case related interactions (e.g., above some minimal number of interactions) are selected for further analysis, where users for whom the number of use-case related interactions that were found is below some required threshold are discarded.

For each user, use-case related interactions having the highest correlation (e.g., above a threshold value, which may be an interaction score threshold) with the use case are identified and used for creating a journey skeleton (block 605). In this way, the method comprises selecting a set of interactions based on the respective interaction scores, and comprises constructing a journey from the selected interactions. Selecting the set of interactions may comprise comparing the interaction score to an interaction score threshold and selecting the set of interactions having an interaction score greater than or equal to the interaction score threshold. To this end, a subset of core use-case related interactions assigned with relatively high scores (e.g., scores above a certain threshold) can be selected to construct the skeleton. Interactions are analyzed as a time series where the skeleton is constructed by distributing the different interactions along a timeline according to their respective time of creation. The method thus concludes with outputting the constructed journey.

Additional interactions can be added to a journey skeleton by time proximity to enrich the journey with valuable data of different types (block 607). Interaction of related areas of interest are identified by applying the corresponding predictor packages, scoring the interactions and applying a scoring method as described above with respect to the core use-case. These interactions can include for example, use-case related interaction with lower scores, interaction related to adjacent markets and/or adjacent topics, conversion related interactions, etc. The final journeys are stored in a database and can be analyzed to identify insights and value points (block 609).

Notably, by identifying many journeys related to the same use-case various insights can be deduced by applying statistical analysis on interaction in the journeys and analyzing their characteristics such as type of interactions, specific combination of interactions, their order, the specific time sequence, etc.

As mentioned above, the journey analysis includes identification of specific behavioral patterns that are indicative of certain user actions or intents. For example, journeys that indicate conversion sessions—e.g., journeys in which the user has made a purchase—are identified based on specific patterns of interactions in the journey that are indicative of a conversion. Furthermore, specific types of conversions can be identified (e.g., purchase, registration, deposit etc.) each by identified a specific pattern of interactions.

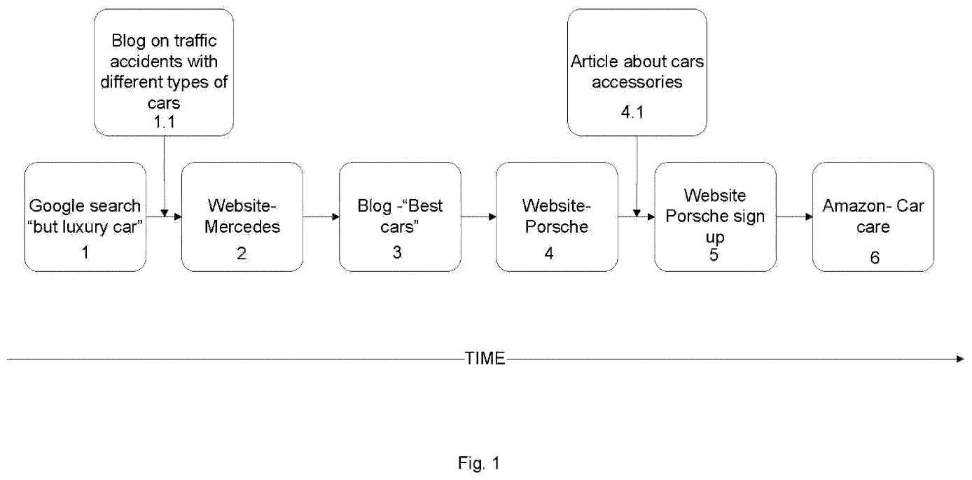

Consider the example related to a car purchase mentioned above with respect to FIG. 1. A use-case description can be automatically generated based on a core domain (e.g., Mercedes) and a few related domains (e.g., of competing companies). The use-case description is used for generating the use-case specific predictors package that includes, a first package for the core-use case, a second package for adjacent markets and a third package for adjacent topics. Once the use-case specific predictors package is available it is used for identifying use-case related interactions in the database. Each interaction is scored (using for example the equation EQ1). Core use-case interaction assigned with high score are considered strongly related to the use-case and are used for creating the skeleton of the journey. Likewise, the other predictors are used for identifying complementary interactions (e.g., related to adjacent markets and adjacent topics). The complementary interactions possibly along with other less strongly related core use-case interactions are added to the journey. FIG. 1 it shows interactions 1-6, which are use-case related and interaction 1.1 which is from an adjacent topic and interaction 4.1 which is from an adjacent market.

It will also be understood that the system according to the presently disclosed subject matter may be a suitably programmed computer. Likewise, the presently disclosed subject matter contemplates a computer program being readable by a computer for executing the method of the presently disclosed subject matter. The presently disclosed subject matter further contemplates a machine-readable non-transitory memory tangibly embodying a program of instructions executable by the machine for executing the method of the presently disclosed subject matter.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

The following clauses are intended for aiding in understanding the present disclosure.

1.

A computer implemented method of detecting use-case related users' interactions from a computer database storing a corpus of interactions generated by many users, wherein each interaction stored in the database is associated with a respective domain and wherein a sequence of interactions performed by a specific user is indicative of a journey that is informative of user's online behavior, the method comprising:
obtaining a use-case description comprising a plurality of textual elements, which are related to the use-case and include at least a core domain and one other related domain; executing a predictors generation process comprising:
for each interaction in a sample of interactions extracted from the database:
   evaluating the interaction to determine compliance with features, wherein each feature is defined based on one or more textual elements in the use-case description and is indicative of a correlation between the interaction and the use-case;
      determining a score for each interaction based on a respective aggregation of features;
      generating, based on the score of each interaction in the sample, a first subgroup of use-case related interactions and a second subgroup of common interactions;
   comparing between textual elements associated with interactions in the first subgroup and textual elements associated with interactions in the second subgroup and identifying a group of non-overlapping textual elements;
   generating from textual elements in the group of non-overlapping textual elements a collection of predictors; and
   applying the collection of predictors on a corpus of interactions for identifying use-case related interactions in the corpus.

2. The computer implemented method of clause 1 further comprising automatically generating the use-case description, comprising:
obtaining a first collection of numerical vectors, each numerical vector representing a respective textual element extracted from the corpus of interactions, wherein textual elements extracted from the corpus of interactions are transformed into their respective numerical vector by a word embedding model that was trained on the corpus of interactions;
obtaining a list of keywords related to the use-case;
retrieving from the database, relevant interactions, according to the list of keywords;
generating a subset of use-case related textual elements that include the keywords in the list and words and expressions extracted from the relevant interaction;
obtaining a second collection of numerical vectors that correspond to the subset of use-case related textual elements;
determining correlation between numerical vectors in the first collection and numerical vectors in the second collection, to thereby identify numerical vectors in the first collection that represent respective textual elements from the corpus of interactions which are contextually correlated to textual elements in the subset of use-case related textual elements; and
generating a use-case description comprising the subset of use-case related textual elements and at least part of the respective textual elements from the corpus of interactions.

3. The computer implemented method of clause 2, wherein automatically generating use-case description further comprises:
determining similarity between numerical vectors of textual elements in the use-case description and numerical vectors in the first collection, to thereby determine whether there is at least one textual element in the use-case description which is contextually correlated with textual elements extracted from interactions stored in the database that are associated with a domain unrelated to a core domain of the use-case; and
if there is, defining the at least one textual element as a negative textual element that indicates negative correlation between the core use-case and an interaction that is associated with the negative textual element.

4. The computer implemented method of clause 2, wherein the list of keywords comprises at least a core use-case domain-name and at least one other related domain-name.

5. The computer implemented method of clause 4, wherein the list of keywords includes no more than 5 keywords.

6. The computer implemented method of clause 4, wherein the list of keywords includes no more than 10 keywords.

7. The computer implemented method of clause 4, wherein the list of keywords includes no more than 15 keywords.

8. The computer implemented method of any one of the previous clauses, further comprising applying a consistency analysis comprising:
applying the word embedding model, on textual elements in the group of non-overlapping textual elements, to thereby
   obtaining a third collection of numerical vectors generated by the word embedding model, each representing a respective textual element in the group of non-overlapping textual elements;
   obtaining a fourth collection of numerical vectors generated by the word embedding model, each representing a respective textual element in the use-case description;
   determining similarity between numerical vectors in the third collection and numerical vectors in the fourth collection, to thereby identify numerical vectors in the third collection that represent textual elements which are contextually correlated with textual elements in the fourth collection; and
   selectively adding to the collection of predictors textual elements which exhibit contextual correlation with textual elements in the use-case description that is greater than a certain threshold value.

9. The computer implemented method of any one of the preceding clauses, further comprising applying sematic correlation, comprising:
obtaining a first group of numerical vectors that correspond to textual elements in the collection of predictors, generated by applying the word embedding model on textual elements in the collection of predictors;
obtaining a second group of numerical vectors that correspond to textual elements in the group of non-overlapping textual elements, generated by applying the word embedding model on textual elements in the group of non-overlapping textual elements;
determining similarity between numerical vectors in the first group and numerical vectors in the second; and to thereby identify numerical vectors in the second group that represent textual elements in the group of non-overlapping textual elements, which are contextually correlated with textual elements in the collection of predictors; and
selectively adding to the collection of predictors textual elements from the group of non-overlapping textual elements which exhibit contextual correlation with textual elements in the collection of predictors that is greater than a certain threshold value.

10. The computer implemented method of any one of the preceding clauses, wherein generating from textual elements in the group of non-overlapping textual elements a collection of predictors comprises:
assigning to each textual element in the group of non-overlapping textual elements a respective score indicative of its probability of being part of the first subgroup and not the second subgroup; and
selectively adding to the collection of predictors textual elements from the group of non-overlapping textual elements that are assigned with a respective score which complies with one or more predefined conditions.

11. The computer implemented method of clause 10, wherein applying the collection of predictors on the interactions in the database and identifying use-case related interactions further comprises:
wherein each interaction is associated with a respective user giving rise to a respective group of user specific use-case related interactions;
for each user, generating from the respective group of user specific use-case related interactions a user-journey, comprising:
constructing a journey skeleton by distributing interactions from the group of user specific use-case related interactions along a timeline according to their respective time of creation.

12. The computer implemented method of clause 11, wherein applying the collection of predictors on the interactions in the database and identifying use-case related interactions, further comprises:
for each interaction in the database:
identifying predictors from the collection of predictors that are found in the interaction;
calculating a respective score for the interaction based on the respective scores of the identified predictors;
determining whether the interaction is use-case related according to the respective scores; and

constructing the journey skeleton using interactions selected according to their scores.

13. The computer implemented method of clause 1, wherein the use-case description further comprises additional textual elements, which are related to an adjacent market or/and an adjacent topic;
wherein the predictors generation process further comprises generating additional predictors, related to an adjacent market and/or an adjacent topic;
applying the additional predictors for identifying additional interactions in the corpus related to the adjacent market and/or adjacent topic.

14. The computer implemented method of clause 13 further comprising:
enriching the journey by adding to the journey skeleton the additional interactions along a timeline according to their respective time of creation.

15. A non-transitory computer readable storage medium tangibly embodying a program of instructions that, when executed by a computer, cause the computer to perform a method of detecting use-case related users' interactions from a computer database storing a corpus of interactions generated by many users, wherein each interaction stored in the database is associated with a respective domain and wherein a sequence of interactions performed by a specific user is indicative of a journey that is informative of user's online behavior, according to any one of clauses 1 to 14.

16. A computer system comprising a processing circuitry comprising at least one processer and computer memory and operatively connected to a computer database comprising a corpus of interactions generated by many users, wherein a sequence of interactions performed by a specific user is indicative of a journey that is informative of user's online behavior, the processing circuitry is configured to execute a method of detection of use-case related users' interactions stored in the database as described in any one of clauses 1 to 14.

17. A computer product operable in a computer and recorded on a non-transitory computer-readable medium for detecting use-case related users' interactions from a computer database storing a corpus of interactions generated by many users, wherein each interaction stored in the database is associated with a respective domain and wherein a sequence of interactions performed by a specific user is indicative of a journey that is informative of user's online behavior, wherein the product incudes a use-case specific predictors package that can be applied on a corpus of interactions for identifying use-case related interactions in the corpus; the computer product is produced by a process comprising:
obtaining a use-case description comprising a plurality of textual elements, which are related to the use-case and include at least a core domain and one other related domain; executing a predictors generation process comprising:
   for each interaction in a sample of interactions extracted from the database:
      evaluating the interaction to determine compliance with features, wherein each feature is defined based on one or more textual elements in the use-case description and is indicative of a correlation between the interaction and the use-case;
      determining a score for each interaction based on a respective aggregation of features;
   generating, based on the score of each interaction in the sample, a first subgroup of use-case related interactions and a second subgroup of common interactions;
   comparing between textual elements associated with interactions in the first subgroup and textual elements associated with interactions in the second subgroup and identifying a group of non-overlapping textual elements;
   generating from textual elements in the group of non-overlapping textual elements the use-case specific predictors package.

1. A computer-implemented method of constructing a journey from a plurality of interactions, the computer-implemented method comprising:
receiving a plurality of interactions from an interactions database;
receiving a use-case;
obtaining a plurality of textual elements for each interaction of the plurality of interactions;
calculating an interaction score for each interaction of the plurality of interactions in the interactions database based on a correlation between the textual elements and the use-case;
selecting a set of the interactions based on the respective interaction scores;
constructing a journey from the selected set of interactions; and
outputting the constructed journey.

2. The computer-implemented method of claim 1, further comprising:
constructing a use-case description using at least some of the plurality of textual elements and the received use-case.

3. The computer-implemented method of claim 2, wherein constructing the use-case description using at least some of the plurality of textual elements and the received use-case comprises:
constructing, using a language model, the use-case description using at least some of the plurality of textual elements and the received use-case.

4. The computer-implemented method of claim 2, wherein obtaining the plurality of textual elements from each interaction comprises:
cleaning the interaction to identify the textual elements; and
obtaining a vector for each identified textual element.

5. The computer-implemented method of claim 4, further comprising:
obtaining at least one vector for the use-case;
calculating a distance between the at least one vector for the use-case and the vector for each identified textual element;
comparing each distance to a proximity threshold; and
constructing a minimal list of textual elements based on the the comparing,
wherein constructing the use-case description using at least some of the plurality of textual elements and the received use-case comprises constructing the use-case description using the minimal list of textual elements and the received use-case.

6. The computer-implemented method of claim 5, wherein constructing the minimal list of textual elements based on the comparing comprises:
discarding any textual elements having a distance greater than or equal to the proximity threshold; and
retaining any textual elements having a distance less than the proximity threshold.

7. The computer-implemented method of claim 6, further comprising:
obtaining metadata of interactions associated with the textual elements that were retained;
determining if the textual elements that were retained are associated with a use-case unrelated to the received use-case; and
discarding any retained textual element that are determined to be associated with a use-case unrelated to the received use-case.

8. The computer-implemented method of claim 5, further comprising:
limiting a number of textual elements in the minimal list of textual elements to a predetermined number of textual elements.

9. The computer-implemented method of claim 8, wherein the predetermined number is at least one of: 5, 10, and 15 textual elements.

10. The computer-implemented method of claim 1, wherein selecting a set of the interactions based on the respective interaction scores comprises:
comparing the interaction score to a relevance score threshold; and
selecting the set of interactions having a relevance score greater than or equal to an interaction score threshold.

11. The computer-implemented method of claim 1, wherein calculating an interaction score for at least some of the interactions in the interactions database comprises:
identifying a plurality of the textual elements from the plurality of interactions as candidate predictors; and
identifying a set of the candidate predictors as a predictors package,
wherein calculating an interaction score for each interaction of the plurality of interactions in the interactions database comprises calculating the interaction score for each interaction based on textual elements in the predictors package.

12. The computer-implemented method of claim 11, wherein identifying a plurality of the textual elements from the plurality of interactions as candidate predictors comprises:
identifying interactions related to the use-case and commonly occurring interactions using associated textual elements and the use-case;
identifying non-overlapping textual elements from the interactions related to the use-case and the commonly occurring interactions; and
obtaining the candidate predictors as the non-overlapping textual elements.

13. The computer-implemented method of claim 12, wherein identifying interactions related to the use-case and commonly occurring interactions using the associated textual elements and the use-case comprises:
identifying a plurality of features associated with the use-case, the plurality of features defining a degree of correlation between a respective interaction of the use-case;
calculating an aggregate score for each interaction based on the features;
comparing the aggregate score for each interaction to an aggregate score threshold; and
identifying interactions relating to the use-case as interactions having an aggregate score greater than or equal to the aggregate score threshold and identifying the commonly occurring interactions as interactions having an aggregate score below the aggregate score threshold.

14. The computer-implemented method of claim 13, wherein identifying a set of the candidate predictors as a predictors package comprises:
calculating a respective probability score for each textual element in the candidate predictors, the respective probability score defining a probability that the textual element is unique to the use-case; and
identifying the set of candidate predictors based on the respective probability score.

15. The computer-implemented method of claim 14, wherein identifying the set of candidate predictors based on the respective probability score comprises:
comparing the respective probability score to a probability threshold;
retaining textual elements having a probability score greater than or equal to the probability threshold in the set of candidate predictors; and
discarding textual elements having a probability score less than the probability threshold.

16. The computer-implemented method of claim 14, wherein calculating an interaction score for at least some interactions of the plurality of interactions in the interactions database based on the associated textual elements comprises:
calculating the interaction score using the respective probability score that was calculated for textual elements associated with the respective interaction.

17. A non-transitory computer-readable medium having instructions stored thereon that when executed by at least one processor causes the at least one processor to perform the computer-implemented method of claim 1.
